(19) United States
(12) Patent Application Publication
(10) Pub. No.: US 2011/0290349 A1
(43) Pub. Date: Dec. 1, 2011

(54) Non-Return Valve Adapter For Water Closet

(76) Inventor: Albert Cozens, Lincolnshire (GB)

(21) Appl. No.: 13/146,979

(22) PCT Filed: Jan. 12, 2010
(86) PCT No.: PCT/GB2010/050030

§ 371 Date: Aug. 22, 2011

(30) Foreign Application Priority Data
Feb. 6, 2009 (GB) 0901920.9
Feb. 13, 2009 (GB) 0902396.1
Sep. 14, 2009 (GB) 0916036.7

(51) Int. Cl. F16K 15/00

(52) U.S. Cl. 137/527.6

(57) ABSTRACT

A non-return valve unit for insertion into a substantially horizontal waste water pipe comprises a horizontal tubular portion (10), and a flange (11) surrounding one end of the tubular portion and angled obliquely to the vertical such that the outer face of the flange, relative to the tubular portion, is directed upwardly. The flange mounts on the upper part of the outer face thereof a pivot (12) carrying a closure member (13) engageable with the outer face to close the tubular portion.

### FIELD OF THE INVENTION

This invention relates to a non-return valve adapter for water closets, to a pan connector for water closets, and to a water closet incorporating such devices.

### BACKGROUND TO THE INVENTION

Conventional water closets discharge to the sewers through a straightforward U-bend water trap to prevent foul odours from the sewerage system entering the building. While this requirement is fulfilled adequately, there are two potential problems which can still arise. Firstly, if flooding occurs in the neighbourhood of the building in which the water closet is located, the flood water can often enter the sewers and cause a back pressure which results in flood water flowing into the building through the water closet. Secondly, it is common in urban areas in particular for the sewers to become colonised by rats, and there have been recorded incidents of rats entering buildings from the sewers through the water closet—they are typically attracted by the light entering the soil pipes through the water closet.

It is desirable, therefore, to provide a non-return valve to prevent flood water or rats from entering the building. There have been various proposals for the use of non-return valves in waste and soil pipes. For example, U.S. Pat. No. 2,089,141 discloses a special elbow pipe fitting incorporating a gravity-actuated non-return valve, the fitting effectively forming part of the U-bend trap. The valve consists of a disc carried by a pivoting L-shaped arm. GB1162001 discloses a non-return valve in the form of a rubber diaphragm which simply flexes to allow water and other matter to pass, and is pushed back against a valve seat in the event of reverse flow. It was intended to prevent foam generated by detergents in the drains from flowing back into a sink. GB2391021 discloses a U-bend incorporating a flap valve, and having a straight branch tube with a lid to provide access for clearing blockages. The U-bend is a relatively complex construction and could only be incorporated into a new installation.

None of these prior art proposals permits the easy installation of a non-return valve into an existing water closet without the need to alter the existing drain or soil pipes.

### SUMMARY OF THE INVENTION

According to the invention, there is provided a non-return valve unit for insertion into a substantially horizontal waste water pipe, the valve unit comprising a horizontal tubular portion, a flange surrounding one end of the tubular portion and angled obliquely to the vertical such that the outer face of the flange, relative to the tubular portion, is directed upwardly, the flange mounting on the upper part of the outer face thereof a pivot carrying a closure member engageable with the outer face to close the tubular portion.

Preferably, a resiliently compressible ring is mounted on or in the outer face of the flange surrounding the tubular portion to provide a fluid-tight seal between the closure member and the flange.

The closure member is suitably provided with a projection on the lower part thereof which, when the closure member rests against the flange engages and conforms with the lower part of the interior of the tubular portion. This may also serve to provide additional weight to ensure that the closure member moves to its closed position more readily under the influence of gravity.

Magnetic means may be provided for holding the closure member against the flange with a predetermined force which can be overcome by dynamic or static pressure of waste water in the tubular portion.

The invention further provides a water closet pan connector, comprising a first end having a first internal diameter and containing a circumferential flexible seal for sealing around a water closet pan outlet, a second end adapted to connect to a soil pipe, and a chamber of greater internal diameter than said first internal diameter, the chamber having mounted therein a non-return valve unit according to the invention.

Another aspect of the invention provides a waste water connector for a drain outlet from a sink, bath, shower tray or the like, comprising a coupling connectable to said outlet, a downstream pipe for connection to a waste pipe, said downstream pipe having a first internal diameter, and a chamber between the coupling and the downstream pipe, the chamber having an internal diameter greater than said first diameter and having mounted therein a non-return valve unit according to the invention.

The adapter of the invention permits an existing water closet to be readily adapted to provide protection against ingress of flood water or access by rats to the interior of a building by way of the soil pipe, without the need for major reconstruction.

### BRIEF DESCRIPTION OF THE DRAWINGS

In the drawings, which illustrate exemplary embodiments of the invention:

FIG. 1 is a side elevation of a valve unit, with the valve open;

FIG. 2 is a corresponding view to that of FIG. 1, with the valve closed;

FIG. 3 is a side elevation of a modified version of the valve unit shown in FIGS. 1 and 2;

FIG. 4 is a diagrammatic side elevation of a water closet pan and cistern, with a pan connector in accordance with one embodiment of the invention fitted thereto, the connector being shown in cross-section;

FIG. 5 is an enlarged cross-sectional view of the pan connector of FIG. 4;

FIG. 6 is a perspective view from above of the connector of FIG. 5, partially disassembled;

FIG. 7 is a perspective view of a partially disassembled sink connector according to another embodiment of the invention; and

FIG. 8 is a similar view to that of FIG. 7, but showing an in-line arrangement for use where a trap has already been fitted to the sink.

### DETAILED DESCRIPTION OF THE ILLUSTRATED EMBODIMENT

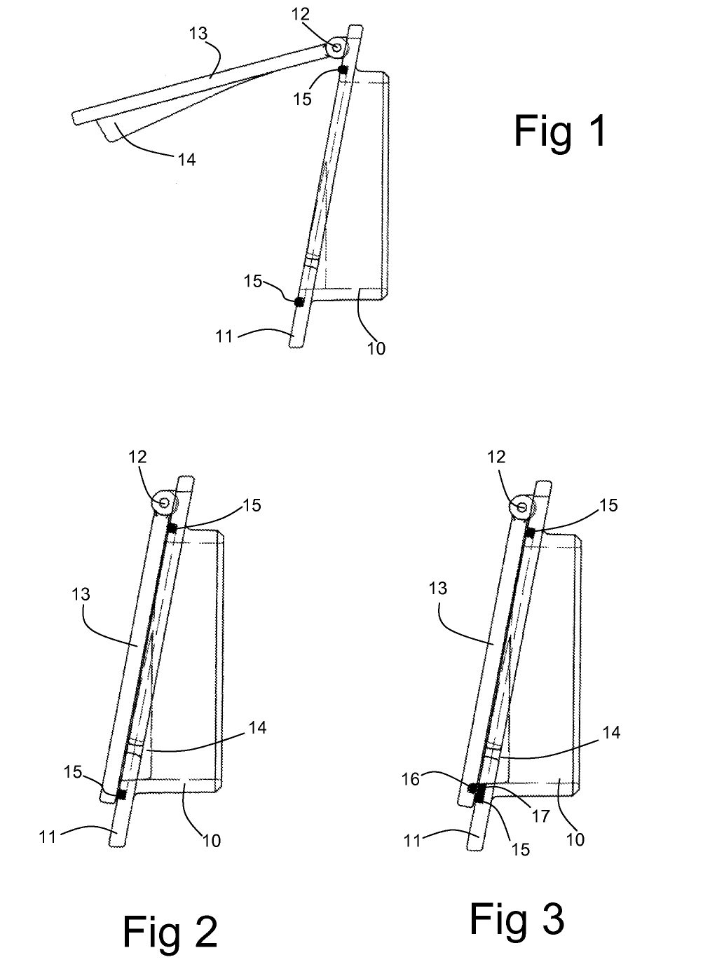

Referring first to FIGS. 1 and 2, the valve unit comprises a short horizontal tubular member 10 surrounded at one end thereof by an oblique flange 11, the tubular section being configured so that it has a shorter horizontal length on the top than on the underside. The uppermost part of the flange 11 carries a hinge 12 on which is pivotally mounted a valve closure flap 13. The flap 13 is moulded with a projection 14 on the lower part thereof which is shaped such that, when the flap 13 rests against the flange 11, the projection engages and conforms with the lower part of the interior of the tubular member 10. The projection 14 also serves to add weight to the lower part of the flap 13, assisting in ensuring that it returns to the closed position under the influence of gravity. A resilient sealing ring 15 is seated in a circumferential groove around the face of the flange 11 to provide a fluid-tight seal between the flap 13 and the flange 11 in use. The flap thus provides a seal against a return flow of water in the event of excess pressure being present in the soil or waste pipe as a result of external flooding or a blockage, or to prevent access by rats to a WC pan. In particular in the latter case, by normally closing off the outlet from the pan, it prevents light from passing through to attract the rats towards the outlet represented by the pan. FIG. 2 shows the valve member in a partially open position in response to flow of water/waste from the WC pan towards the soil pipe and sewer.

The embodiment illustrated in FIG. 3 is modified from the previous embodiment by the provision of a magnet 16 embedded in the face of the flap and a ferromagnetic strip 17 embedded in the flange just inside the ring 15, the magnet 16 co-operating with the strip 17 to hold the flap closed against the ring 15, further ensuring a fluid-tight seal in use. The magnet 16 is chosen to ensure that, when the static or dynamic pressure of water against the inner face of the flap exceeds a predetermined value, the magnetic attraction between the magnet and the strip is overcome, allowing the flap to open.

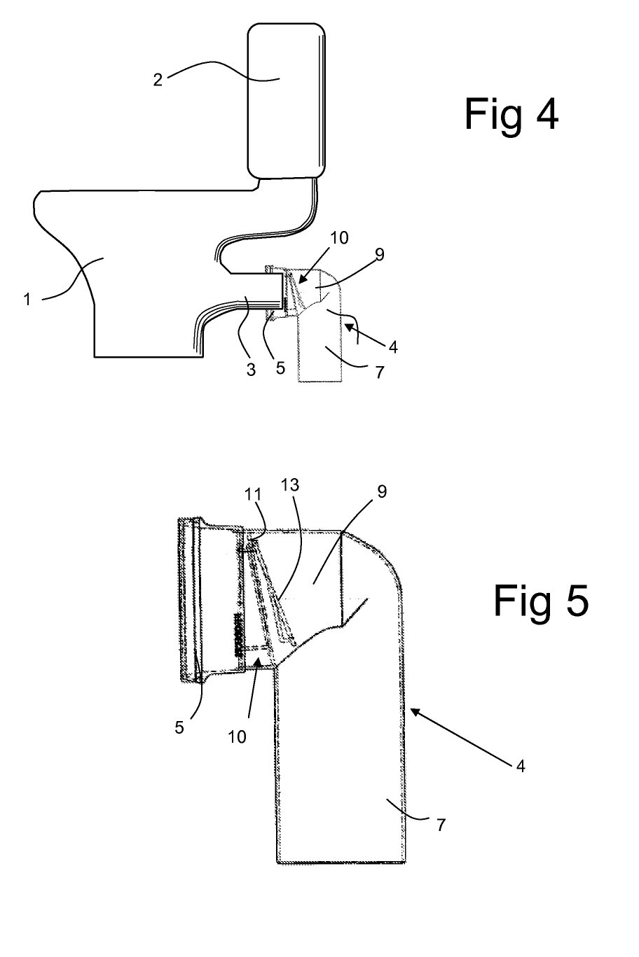

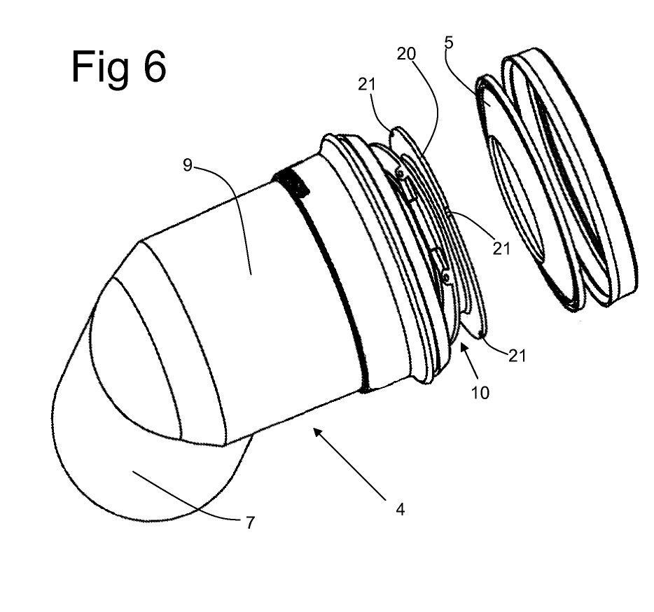

FIG. 4 shows a conventional water closet pan 1 and close-coupled cistern 2, the pan having a generally horizontal outlet pipe 3 which is conventionally received as a push-fit in a pan connector valve unit 4 which is connected in turn into a connector on the end of the vertical soil pipe (not shown). The pan connector 4 is in the form of a horizontal socket containing a resilient seal 5 in the form of a series of circumferential deformable ribs which resiliently deflect and deform when the outlet pipe 3 is received in it, and a vertical pipe 7 leading downwardly from it. An enlarged chamber 9 is located at the uppermost part of the pipe 7, and a valve unit 10 of the type shown in FIG. 1-2 or 3 is located between the chamber and the seal 5. The chamber is dimensioned to permit the valve flap 6 to open in it. FIG. 5 shows the connector 4 in more detail, while FIG. 6 shows the valve unit 10 and seal 5 disassembled from the connector 4. It will be seen that the valve unit is provided with a secondary flange 20 around the tubular portion to permit it to locate the unit against a shoulder within the connector. The shoulder is provided with several moulded tabs (not shown) spaced apart around it, while the secondary flange 20 has slots 21 to engage the tabs to locate the unit. The tabs and slots are positioned to ensure that the unit 10 can only be fitted in the connector in its correct orientation.

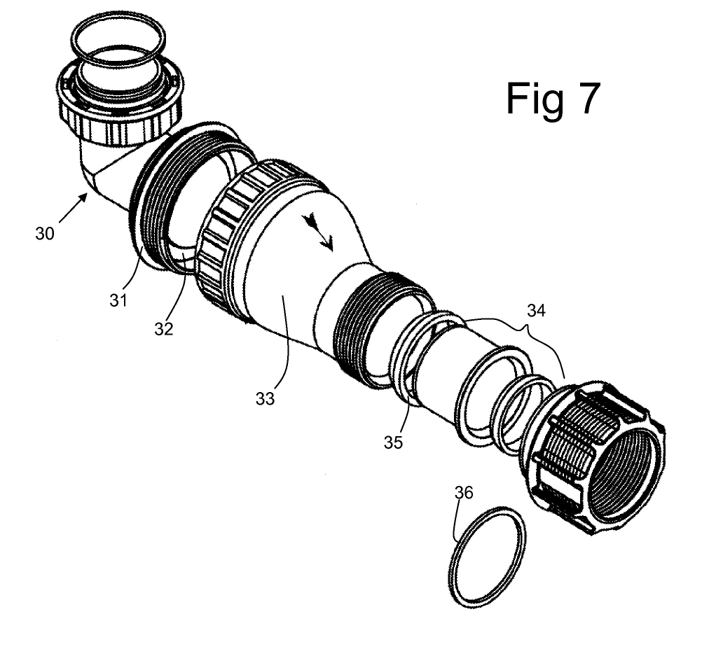

FIG. 7 shows a sink connector or the like, having an elbow fitting 30 engageable on the sink (or bath or shower tray or the like) outlet and with an enlarged (relative to the normal waste pipe diameter) screw-threaded portion 31 having an internal circumferential flange 32 on which the valve unit (not shown, but of the type shown in FIGS. 1 and 2 or FIG. 3) can be located, for example in the manner described with respect to the pan connector 4 shown in FIG. 6. A chamber 33 fits on to the portion 31, the enlarged internal diameter providing space for the valve flap to open. The chamber 33 has a reduced diameter end corresponding to a normal waste pipe size. A reducing seal arrangement 34 is shown, providing for coupling to smaller diameter waste pipe or trap, where this is required; for the larger size the reducing arrangement can be omitted and the connection made with the conical seal 35 and rigid seal 36 shown separately.

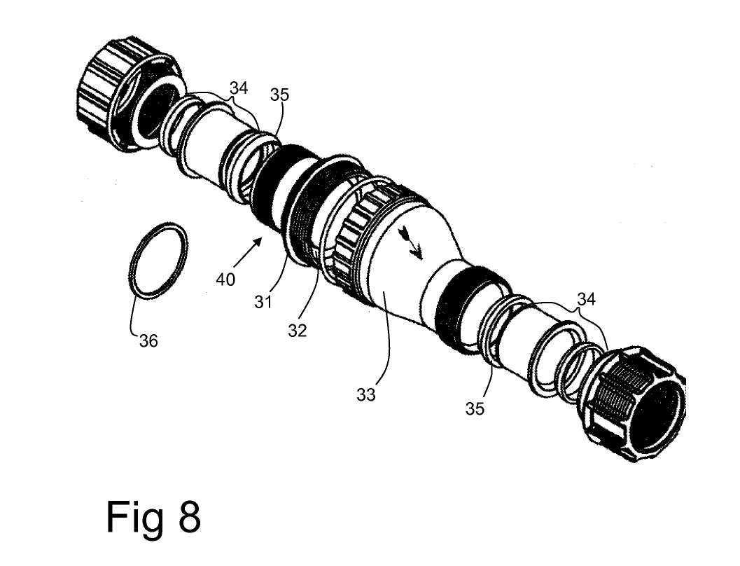

FIG. 8 shows an alternative configuration of the connector shown in FIG. 7, in which the elbow fitting 30 is replaced by a straight fitting 40 for connection to an existing waste pipe downstream of a trap. This is dimensioned for the larger size (for example 40 mm diameter) of waste pipe. For the smaller (e.g. 32 mm diameter) pipe, another reducing seal arrangement 34 is employed, as illustrated.

1. A non-return valve unit for insertion into a substantially horizontal waste water pipe, the valve unit comprising a horizontal tubular portion, a flange surrounding one end of the tubular portion and angled obliquely to the vertical such that the outer face of the flange, relative to the tubular portion, is directed upwardly, the flange mounting on the upper part of the outer face thereof a pivot carrying a closure member engageable with the outer face to close the tubular portion.

2. A non-return valve unit according to claim 1, wherein a resiliently compressible ring is mounted on or in the outer face of the flange surrounding the tubular portion to provide a fluid-tight seal between the closure member and the flange.

3. A non-return valve unit according to claim 1 or 2, wherein the closure member is provided with a projection on the lower part thereof which, when the closure member rests against the flange engages and conforms with the lower part of the interior of the tubular portion.

4. A non-return valve unit according to claim 1, 2 or 3, comprising magnetic means for holding the closure member against the flange with a predetermined force which can be overcome by dynamic or static pressure of waste water in the tubular portion.

5. A water closet pan connector, comprising a first end having a first internal diameter and containing a circumferential flexible seal for sealing around a water closet pan outlet, a second end adapted to connect to a soil pipe, and a chamber of greater internal diameter than said first internal diameter, the chamber having mounted therein a non-return valve unit according to any preceding claim.

6. A water closet pan connector according to claim 5, wherein the chamber is located in a first, horizontal section of the connector, and the second end extends vertically.

7. A waste water connector for a drain outlet from a sink, bath, shower tray or the like, comprising a coupling connectable to said outlet, a downstream pipe for connection to a waste pipe, said downstream pipe having a first internal diameter, and a chamber between the coupling and the down-stream pipe, the chamber having an internal diameter greater than said first diameter and having mounted therein a non-return valve unit according to any of claims 1 to 5.
